(19) United States
(12) Patent Application Publication
(10) Pub. No.: US 2017/0105019 A1
(43) Pub. Date: Apr. 13, 2017

(54) HIGH FRAME RATE TILING COMPRESSION TECHNIQUE

(71) Applicant: THOMSON LICENSING, Issy les Moulineaux (FR)

(72) Inventors: William REDMANN, Glendale, CA (US); Pierre Hugues Routhier, Varennes (CA)

(21) Appl. No.: 15/315,152

(22) PCT Filed: May 5, 2015
(86) PCT No.: PCT/US2015/029149

§ 371 Date: Nov. 30, 2016

Related U.S. Application Data
(60) Provisional application No. 62/034,248, filed on Aug. 7, 2014.
(60) Provisional application No. 62/005,397, filed on May 30, 2014.

(51) Int. Cl. H04N 19/51; H04N 19/174; H04N 19/159

(52) U.S. Cl. CPC H04N 19/51; H04N 19/159; H04N 19/174

(57) ABSTRACT

A method for processing high frame rate source content includes tiling images of the source content into at least one image block having a second frame rate lower than the high frame rate of the source content. After tiling, at least one operation on the at least one image block is performed. Successive images tiled in the at least one image block are then selected for sequential display at the high frame rate.

### CROSS-REFERENCE TO RELATED APPLICATIONS

This application claims priority under 35 U.S.C. 119(e) to U.S. Provisional Patent Application Ser. No. 62/005,397, filed May 30, 2014 and U.S. Provisional Patent Application Ser. No. 62/034,248 filed Aug. 7, 2014 the teachings of which are incorporated herein.

### TECHNICAL FIELD

This invention relates to video compression and more particularly to compression of high-frame rate video.

### BACKGROUND ART

In the United States, television broadcasters historically transmitted television programs over broadcast channels using a standard definition format (about 480 lines of picture) at 30 frames per second, with interlaced fields at 60 fields per second. Transmitting television content in the standard definition format provides a good sense of motion (e.g., for sports broadcasts) and compensates well for phosphor decay times associated with television sets with cathode ray tubes. Television broadcasters have now converted from standard definition to high definition (HD). There now exist two primary HD formats: 1080i, which is interlaced and 720p, which is progressive. Slow moving content benefits from higher spatial resolution at 1080i (60 fields per second) while fast action like sports benefits from higher temporal resolution of 720p (60 frames per second. Recently, television broadcasters have started to migrate Ultra high-resolution formats with resolutions as high 2160 p lines of picture (3840×2160 pixels). Consequently, interlaced formats now find less favor with broadcasters.

Many recently introduced high-definition consumer display systems include stereoscopic 3D as a supported format using progressive scan. Such 3D display systems deliver separate left- and right-eye images of stereoscopic image pairs to each eye, generally with the assistance of compatible glasses. Some video distribution schemes encode 3D as a single image and make use of a disparity map to create the left- and right-eye images. However, a majority of 3D video distribution mechanisms (e.g., Blu-Ray™ disks, and 3D broadcasts in North America) rely on packing a left- and right-eye image pairs into a single composite frame, typically 3840×1080 pixels. For 3D Blu-Ray™ disks, a full size left- and right-eye image pair are tiled over/under into a single oversized framed.

The composite image, when viewed naively at the receiving end, will include both images of each stereoscopic pair, combined together in one of several alternative ways, each of varying intelligibility. However, when properly decoded, each of the images will appear to fill the screen, and each appears only to the left or right eye as appropriate. The SMPTE standard ST 2068:2013—Stereoscopic 3D Frame Compatible Packing and Signaling for HDTV, as published Jul. 29, 2013 by the Society of Motion Picture and Television Engineers of White Plains, N.Y., describes one well-known mechanism for signaling the arrangement providing the stereoscopic image pairs.

Today, some television broadcasters have begun broadcasting Ultra-High Definition (UHD) content at relatively low frame rates. For certain television content, particularly sports, having a high frame rate yields a superior viewing experience. Unfortunately, high frame rate capable systems do not widely exist and do not pervade distribution channels. Further, the introduction of smaller timing units (e.g., 1/120th second) into the broadcast chain can present difficulties for time code-sensitive devices, such as switchers and editors, for example, which would need to switch among different frame rate content. For example, a time-code sensitive device might need to make a switch (e.g., at the top of the hour) to a different program, only to find that an odd number of 120 fps frames have left the pipeline mid-frame (at the lower frame rate) when the switch should occur, an unacceptable circumstance. As a result, there presently exists no practical way to deliver high frame rate content through a conventional broadcast channel.

Thus, a need exists for processing high frame rate content to overcome the aforementioned disadvantages.

### BRIEF SUMMARY

Briefly, a method for processing high frame rate source content commences by tiling images of the source content into at least one image block having a second frame rate lower than the high frame rate of the source content. After tiling, at least one operation on the at least one image block is performed.

In accordance with another aspect of the present principles, a method for displaying images tiled in at least one image block having a first frame rate includes the steps of selecting successive frames tiled in the at least one image block and sequential providing the selected frame for display at a second frame rate higher than the first frame rate.

### BRIEF SUMMARY OF THE DRAWINGS

FIG. 1 illustrates a process for capturing a sequence of high frame rate images and packing them into lower frame rate image blocks suitable for compression using I- and P-frames in accordance with a first aspect of the present principles;

FIG. 2 illustrates a process of unpacking high frame rate images from the low frame rate image blocks of FIG. 1 for display;

FIG. 3 illustrates in flow chart form the steps of a method for the packing high frame rate images into lower frame rate image blocks as depicted in FIG. 1 and for subsequently unpacking such image lower frame rate blocks as depicted in FIG. 2;

FIG. 4 illustrates a descriptive timing diagram for the packing and unpacking method of FIG. 3 showing near minimum timing requirements;

FIG. 5 illustrates a process for capturing a sequence of high frame rate images and packing them into lower frame rate image blocks suitable for compression using I-, P-, and B-frames in accordance with a second aspect of the present principles;

FIG. 6 illustrates a process for unpacking high frame rate images from the lower frame rate image blocks of FIG. 5 for display;

FIG. 7 illustrates, in flow chart form, the steps of a method for packing high frame rate images into lower frame rate image blocks as depicted in FIG. 5 and subsequently unpacking them as depicted in FIG. 6;

FIG. 8 illustrates a descriptive timing diagram for the packing and unpacking method of FIG. 7 showing near minimum timing requirements;

FIG. 9 illustrates in flow chart form a method for each of the packing and unpacking processes of the present principles;

FIG. 10 illustrates several exemplary low frame rate image blocks packed with high frame rate 2D images and stereoscopic 3D images;

FIG. 11 illustrates a variety of exemplary encoding sequences for the packing process depicted in FIG. 1;

FIG. 12 illustrates a variety of exemplary encoding sequences for the unpacking process depicted in FIG. 2; and

FIG. 13 illustrates a block diagram of an exemplary high frame rate processing system in accordance with the present principles.

### DETAILED DISCUSSION

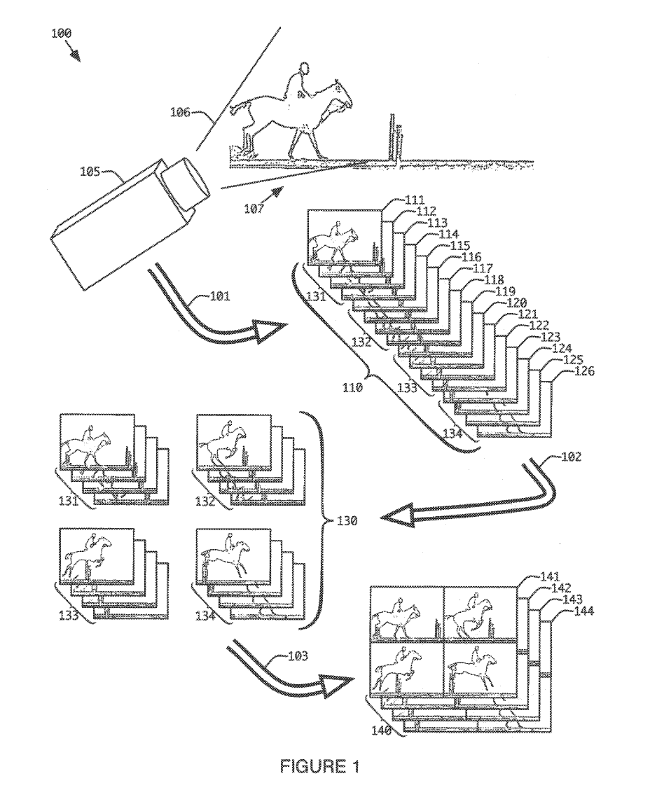

FIG. 1 illustrates a frame rate compression technique 100 that includes a step 101 in which a high frame rate (HFR) image stream is captured (or in other embodiments, created). In the illustrated embodiment of FIG. 1, a HFR camera 105, with a field of view 106 subtending a subject 107, generates a high frame rate image stream, a portion 110 of which comprises individual sequential images 111-126. In the illustrative embodiment of FIG. 1, and as depicted in other figures, the subject 107 captured by the camera 107 comprises a man riding a horse. The images 111-126 of the subject 107 appear in FIG. 1, as well as in the other figures, with an exaggerated timescale so that the individual images exhibit clearly discernable differences. The images 111-126 correspond to the images in the work “Jumping a hurdle, black horse” by Eadweard Muybridge, 1887. These images were chosen because of their familiarity to many and therefore they present a recognizable sequence helpful to the understanding of this invention.

The images 111-126 in the stream portion 110 captured during step 101 of FIG. 1 undergo accumulation in a capture buffer 130 during step 102, thereby yielding a set of sub-sequences 131-134. During step 103, the sub-sequences 131-134 undergo encoding to pack the sub-sequences (which comprise HFR images) into a set 140 of lower-frame rate (LFR) image blocks 141-144. For example, the first image of each of the sub-sequences 131-134 undergoes consolidation into the single LFR image block 141. Likewise, the second image from each sub-sequence undergoes consolidation into the lower frame rate image block 142, and the third image and fourth image from each sub-sequence are packed into image blocks 143 and 144, respectively.

Throughout this document, the term “image block” is used to identify the lower frame rate images obtained by tiling a group of images from the higher frame rate source content, whereas “image” is used alone to refer to individual frames of the source content or reconstructions thereof. In different embodiments, an image block may be larger, the same size as, or smaller than an individual image, as will be discussed in detail below.

Under circumstances when image compression can prove desirable, the LFR image blocks 141-144 can undergo compression (also known as “coding”) individually, for example using well-known JPEG or JPEG-2000 compression schemes. Alternatively, when encoded using a motion-based compression scheme, such as MPEG-2 or H.264/MPEG-4, then LFR image blocks 141-144 form an encoded “group of pictures” (GOP) 140. Such motion-based compression schemes typically make use of three kinds of frame encoding, I-frames, P-frames, and B-frames. I-frames comprise “intra coded” frames, that is, I frames undergo encoding without any reference to other frames, and therefore can stand alone. P-frames or “predicted frames” constitute frames encoded relative to a previous reference frame or frames and exploit the redundancies between frames for efficient representation (generally, a representation smaller than for an I-frame). B-frames, or “bi-directional predicted” frames undergo encoding by exploiting similarities between both prior and later reference frames.

A significant portion of the encoding process for P- and B-frames identifies regions in the reference frame(s) also present in the frame undergoing compression (encoding). The encoding process for such frames also estimates the motion of such common regions to enable encoding them as a motion vector. In some embodiments, encoders can use not just I-frames as references, but other P- or B-frames as well. The motion vector representation for a region of the current frame is usually more compact than a more explicit representation for the region's pixels.

Note that the tiling of the HFR images 111-126 into the LFR image blocks 141-144 shown in FIG. 1 retains the temporal ordering and sequential nature of sub-sequences 131-134, which provides the advantage of maintaining the differences between consecutive HFR images, for example in the sub-sequence 131, after composition (tiling) into the LFR image blocks 141-144. Accordingly, since the HFR temporal resolution exceeds that of LFR, the expected motion vectors between consecutive HFR images will generally have a smaller size than those for a captured sequence (not shown) at a lower frame rate. Likewise, the corresponding regions between consecutively captured images will generally have more similarity than if the capture frame rate were slower, since less time has passed between consecutive images of the subject at the HFR.

The tiling of high frame rate images into lower frame rate image blocks in accordance with the present principles will increase the effectiveness of compression schemes that exploit motion in the composite images in the encoded GOP 140. Within each quadrant of those composite image blocks, the apparent temporal increment between consecutive LFR image blocks 141-144 corresponds to the HFR, even though delivery of the image blocks 141-144 of the GOP 140 occurs at the LFR. However, a temporal discontinuity will occur in each quadrant between the last LFR image block 144 of the current encoded GOP 140 and the first LFR image block (not shown) of the next GOP (not shown). The magnitude of this temporal discontinuity in the example of FIG. 1 is 3× the LFR interval, or 12× the HFR interval. Because of this temporal discontinuity, compression schemes that attempt to exploit similarity between the end of one GOP and the start of the next GOP (i.e., using B-frames) will not fare particularly well. Accordingly, traditional motion encoding techniques for use with the present principles will preferably be limited to I-frames and P-frames.

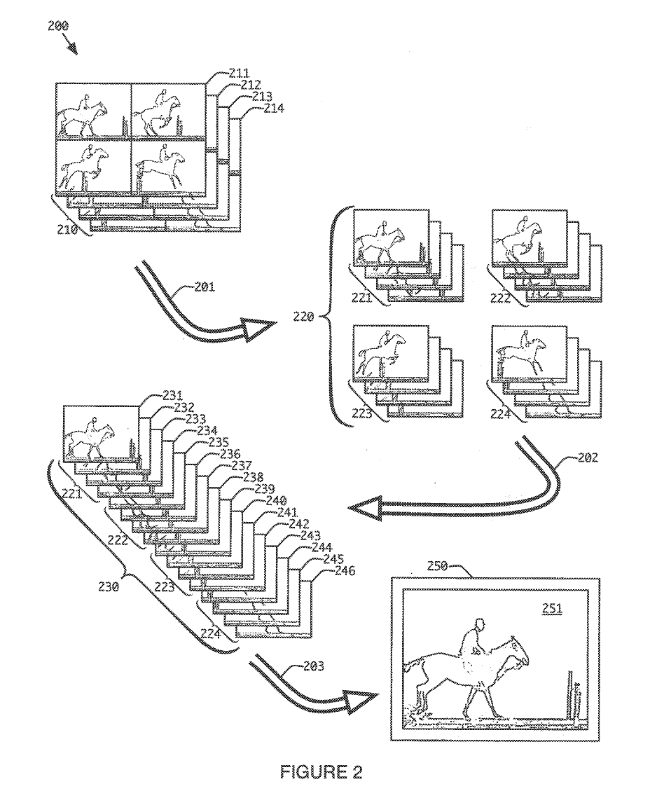

FIG. 2 illustrates a corresponding frame rate decompression process 200. During the process 200, an encoded GOP 210, corresponding to the encoded GOP 140 of FIG. 1 and representing composite LFR image blocks 211-214, undergoes decoding during step 201 to decompress the LFR image blocks 211-214 for storage in a decoded image buffer 220. Each of the quadrants of the image buffer 220 will thus receive consecutive HFR image sub-sequences 221-224. An output process executed during step 202 arranges the sub-sequences 221-224 into a reconstructed high frame rate image sequence 230 which consists of HFR images 231-246 suitable for display during step 203, for example on a display device 250, typically as an HFR presentation 251.

Those skilled in the art will recognize that image buffers such as 130 and 220 do not need discrete, separated quadrants (e.g., quadrants containing sub-sequences 131-134 and 221-224) or separated LFR image block planes. These separations can exist as logical distinctions within an otherwise homogeneous memory array, though in other embodiments, very definite physical distinctions can exist between each of the LFR image block planes and/or quadrants, for example within an FPGA or ASIC to support a particular encoding or decoding image processing pipeline.

The tiling of high frame rate (HFR) images into low frame rate (LFR) image blocks in accordance with the present principles enables processing of the LFR image blocks, such as editing, or other operations, by conventional apparatus transitionally used for low frame rates. Once the LFR image blocks have undergone one or more processing operations, such as editing or the like, the individual HFR sub-sequences can be arranged into the reconstructed images sequence 230, which consists of HFR images 231-246 suitable for display during step 203.

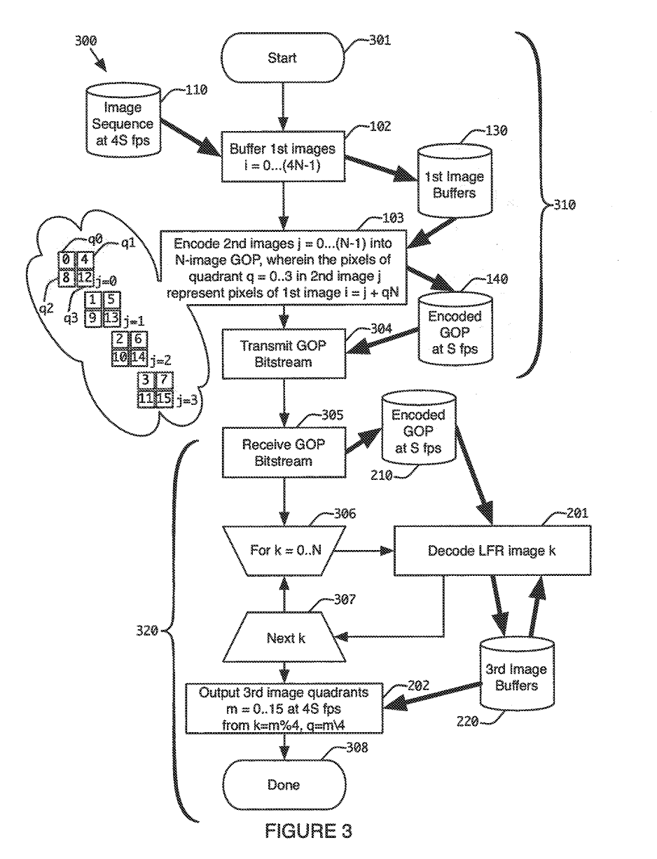

FIG. 3 shows a HFR encoding/decoding process 300 in flow chart form in accordance with an aspect of the present principles. As depicted in FIG. 3, an encoding stage 310 produces an encoded GOP 140, for example as a bitstream, suitable for decoding by a decoding stage 320. The encoding performed by the encoding stage 310 commences at step 301 with receipt of HFR image sequence 110 so that during the capture step 102, the first image buffer 130 buffers the received images. In this example, the HFR typically comprises “4S”, that is, four times the LFR designated as ‘S’. In a practical implementation of this embodiment, ‘S’, the LFR, might comprise 30 frames per second (fps) in which case the HFR, being 4S, would be 120 fps. The encoding that occurs during step 103 of FIG. 3 is consistent with the encoding depicted in FIG. 1 in which the number ‘N’ of LFR image blocks in a GOP is four. These ‘N’ LFR image blocks collectively correspond to 4N HFR images, that is, sixteen. Accordingly, the images under consideration in the capture buffer 130 have consecutively numbering 0 . . . 4N−1 (i.e., 0 . . . 15) and selection occurs in accordance with an index value ‘i’. Indexing of the ‘N’ LFR image blocks occurs in accordance with the index value ‘j’, which takes the values from 0 to N−1 (i.e., 0 . . . 3). Here, ‘q’, which takes the values 0 . . . 3 identifies a corresponding one of the four quadrants. In this exemplary embodiment, the following equation specifies the relationship between the HFR images in capture buffer 130 and the tiling into the LFR image blocks for the encoded GOP 140:

LFR_Image[j].quadrant[q]=HFR_Image[i], for j=0 . . . 3, q=0 . . . 3, where i=j+qN Equation 1:

The encoded GOP 140 can undergo streaming during step 304 to another device for decoding or may be stored as a non-transient file for subsequent decoding.

In one embodiment of the decoding stage 320, the received stream can undergo storage as encoded GOP 210 during step 305 as shown. Alternatively, the encoded GOP 210 can undergo receipt as a file. The decompression (decoding) performed during execution of a loop beginning with step 306 occurs once per LFR image block for decoding, herein indexed as ‘k’, where k runs consecutively from 0 . . . N−1 (i.e., 0 . . . 3). This decoding works well for embodiments that make comprised of only I-frames or both I- and P-, since a P-frame can only reference a frame or frames that precedes it. As each LFR image block (e.g., 211-214) undergoes decoding and storage in the decoded LFR image block buffer 220, the individual quadrants q (0 . . . 3) will correspond to a decompressed HFR image ‘m’, where m runs from 0 . . . 4N−1 (i.e., 0 . . . 15) and m=4q+k. When the decompression loop completes at step 307 or, in a tightly pipelined architecture, a fraction of an HFR frame interval sooner, the output process 202 provides restored HFR images (e.g., 231-246) in the reconstructed image sequence 230, indexed by m, and ready for presentation during step 203, for example to the HFR display device 250.

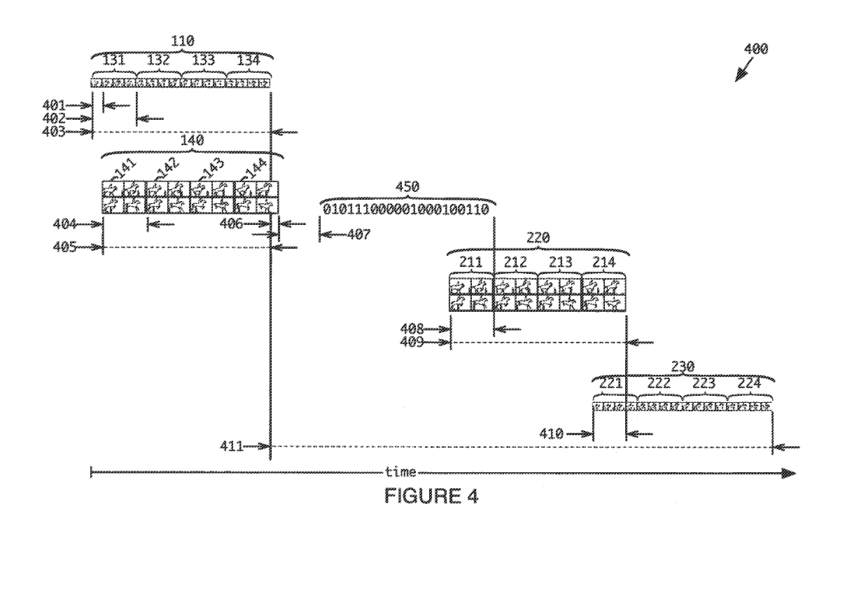

FIG. 4 shows a timing diagram 400 illustrating an exemplary execution of the HFR encoding/decoding process 300. Generally, time advances in FIG. 4 from left to right, though not within an individual image. For example, sub-sequence 131 comprises four individual HFR images so these images can be presented sequentially. However, within these individual HFR images, there exists no indication of a temporal context other than when image capture starts and ends (e.g., no implied ordering or timing of pixels, rows, or columns) Likewise, the encoding process, which creates the encoded GOP 140, takes place at the time encoded GOP 140 appears (plus additional computational time as necessary), but individual LFR image blocks, e.g., image block 141, are not temporally representative.

The HFR frame time 401 equals the reciprocal of the HFR. The first sub-sequence 131, comprising the four images 111-114 as depicted in FIG. 1, spans the interval 402, comprising a period four times the HFR frame time 401. The interval 403 represents the time for presenting the sixteen images 111-126 (from FIG. 1) of stream portion 110. The duration represented by the LFR frame time 404 is the reciprocal of the LFR, but does not correspond to an LFR image being available at the time shown. As an example, the LFR image block 141 comprises four quadrants, each populated from the first HFR image in each of the four sub-sequences 131-134. Thus, the total image content for LFR image block 141 remains indeterminate until no sooner than the receipt of the first image of sub-sequence 134 is completed.

Likewise, the total image content for the LFR image block 144 remains indeterminate until no sooner than complete receipt of the last image of sub-sequence 134. Accordingly, the encoding process 103 begins following some latency interval after capture of the first HFR image of sub-sequence 131 begins. Here, by way of example, the latency corresponds roughly to one HFR frame time. The interval 405 runs from the start of the encoding process 103 to the time when capture of sequence 110 completes. The interval 406 (not to scale) represents the remaining portion of the encoding process 103. Once encoded, the GOP 140 becomes complete but an arbitrary latency occurs, which by way of example in a real-time streaming application, would include (a) transmit latency 407 comprising a setup time to ready the encoded GOP 140 for transmission, a transmit buffer wait time, and an actual network transport latency, (b) the actual network transport duration, here represented as the width of bitstream segment 450, and (c) a receive-buffer wait time 408. The received and buffered bitstream segment 450 corresponds to the encoded GOP 210. Note that in this example, the receive-buffer wait time 408 has negative value such that decoding process 201 begins to populate the decoded image buffer 220 from the bitstream segment 450 (e.g., the encoded GOP 210, symbolically illustrated herein as a few nonsensical bits) even before the complete receipt of the bitstream segment. (In an alternative embodiment, this receive buffer wait time 408 could have a positive value, and could be several seconds long, providing a deep receive buffer, which can allow for missing packet replacement or forward error correction techniques).

The decoding process 201 takes place through interval 409, during which decoded LFR image block buffer 220 populates with LFR image blocks. Within the buffer 220, each of the four LFR image blocks 211-214 undergoes decoding, its respective quadrants corresponding to sub-sequences 221-224 (as shown by the sub-sequence groups in buffer 22 in FIG. 2). The output process 202 provides the restored HFR images 231-246 (from FIG. 2), at a rate of one per HFR frame interval, in order, from the sub-sequences 221-224 in the reconstructed image sequence 230. The output buffer wait time 410, in this example, also has a negative value, indicating that the output of image sequence 230 can begin before the decoding process 201 has finished filling the decoded LFR image block buffer 220. In this example, the wait time 410 has a negative value, about negative three times the HFR frame time, suggesting that the output of the first three HFR image of the sub-sequence 221 could be performed, but that the output of the fourth (last) image of sub-sequence 221 requires the decoding process 201 to finish populating buffer 220 with the LFR image block 214. Ultimately, the total pipeline latency 411 corresponds to an interval measured from the time the sub-sequence 134 finishes capture to the time corresponding to the sub-sequence 224 finishes its output. Note that embodiments where files serve to store a time-compressed image sequence for later playback, the interval between the encode process 310 and the decode process 320 can have an arbitrarily long value.

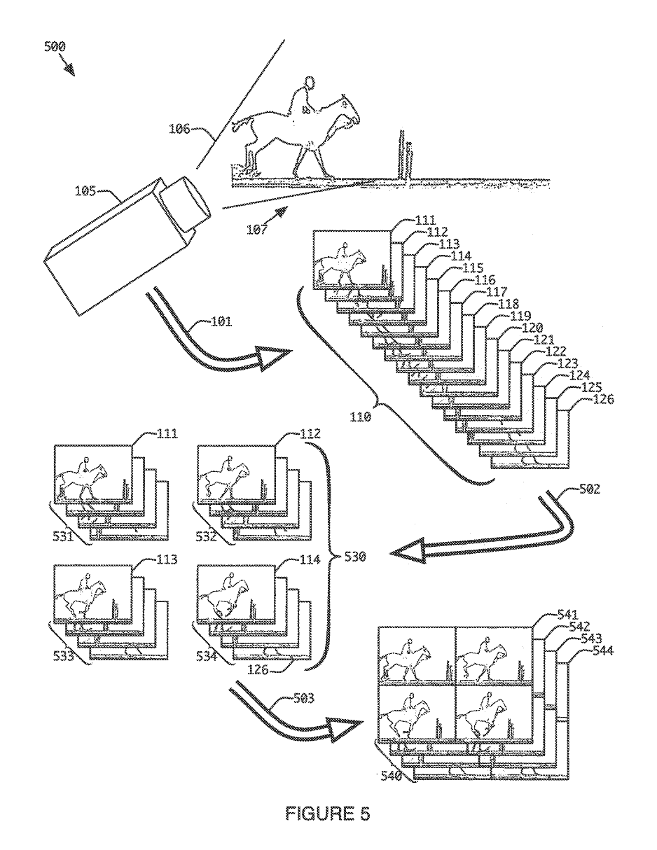

FIGS. 5-8 illustrates a slightly different embodiment of the invention, wherein each consecutive HFR image is placed into a different quadrant of the same LFR image block, until that LFR image block is filled, after which subsequent LFR image blocks are similarly constructed. FIG. 5 shows a second frame rate compression process 500 using a similar creation (or capture) process 101 for producing an HFR image stream of which a portion 110 appears as before. During the capture step 502, the images 111-126 of the stream portion 110 accumulate in a capture buffer 530, but sub-sequences, such as sub-sequence 131 in FIG. 1 comprising HFR images 111-114, undergo distribution to the four quadrants 531-534 (or other regular division) so that during the encoding process 503, when packed into LFR image blocks 541-544, a sub-sequence of HFR images (e.g., images 111-114) are packed and encoded into a single LFR image block (e.g., image 541). Likewise, the HFR images from the second sub-sequence (132 in FIG. 1) undergo encoding into an HFR image 542, and so on, yielding the encoded GOP 540.

It is important to note that composite LFR image blocks 541-544 of FIG. 5 have one particular property that differs from the LFR image blocks 141-144 of FIG. 1: In any particular quadrant of the consecutive LFR image blocks 541-544, the difference in timing between the corresponding HFR images (e.g., for the top-left quadrant, between each of HFR images 111 and 115, 115 and 119, 119 and 123) remains a constant, corresponding to the frame rate of the LFR image blocks. This remains true not just within the encoded GOP 540, but also as between consecutive GOPs; whereas for any particular quadrant of consecutive LFR image blocks 141-144, the difference in timing from the corresponding consecutive HFR images (e.g., for the top-left quadrant, HFR images 111 and 112, 112 and 113, 113 and 114) also remains constant, though corresponding to the frame rate of the HFR images, but this condition only exists internal to the encoded GOP 140 and differs radically between consecutive GOPs, where the difference in timing jumps to twelve HFR frame intervals (or three LFR image block intervals).

A disproportionately large temporal gap (twelve HFR intervals) exists between the HFR images represented in a given quadrant between the consecutive LFR image blocks at the end of one GOP (e.g., LFR image block 144 in the encoded GOP 140) and the start of the next GOP (not shown, but similar to first-in-GOP LFR image block 141). For this reason, the encoding of a GOP using bi-directional frame encoding (B-frames) remains unsuitable since the first LFR image block of the next GOP will be too dissimilar to reliably be of value in predicting images within in GOP 140. The arrangement shown in FIG. 5 remedies this problem since each consecutive LFR image block within a GOP (e.g., 540) or between GOPs (next GOP not shown) has a constant temporal offset between like portions of its predecessor. Accordingly, bi-directional encoding between frames of GOP 540 and the next GOP (not shown) remains as practical as bi-directional encoding among the frames in the GOP 540.

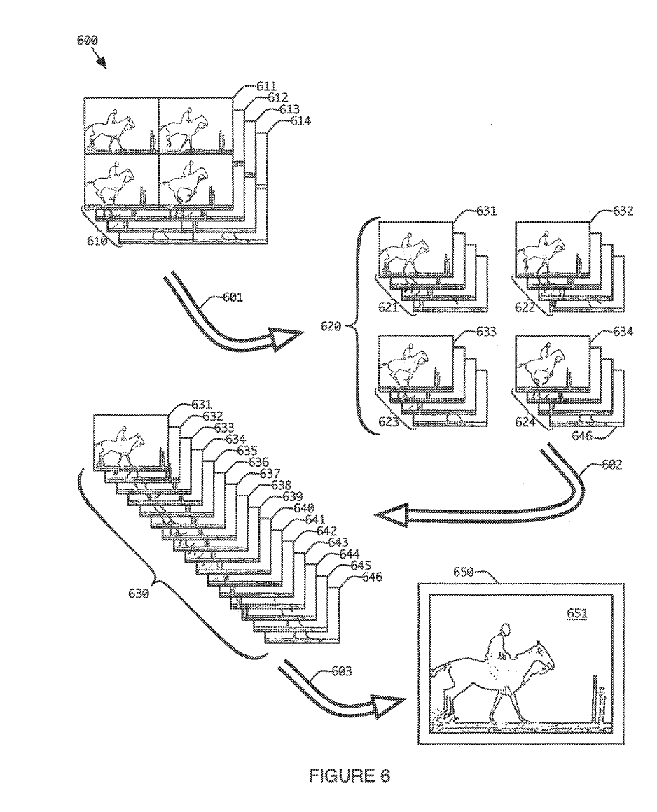

FIG. 6 shows a frame rate decompression process 600 that corresponds to the frame rate compression process 500 of FIG. 5. Here, the encoded GOP 610 corresponds to the encoded GOP 540 and represents the composite LFR image blocks 611-614. The decoding process 601 receives the encoded GOP 610. The decoding process 601 then decompresses the LFR image blocks 611-614 into decoded image buffer 620. Each of the planes in the image buffer 620 will thus receive sub-sequences of consecutive HFR images, for example, HFR images 631-634. The output process 602 selects the HFR images (e.g., 631-634) of the sub-sequence in the first plane from each of the quadrants 621-624, consecutively, before proceeding to the next plane. Ultimately, the output process 602 will select the HFR image 646, thereby reconstructing the image sequence 630, which is comprised of HFR images 631-646 suitable for presentation during step 603, for example for display on the display device 650 as the HFR presentation 651. Note that when inter-GOP bi-directional encoding is being used, decoding of some LFR image blocks (e.g., 612-614) may require receipt of and access to a first I-encoded LFR image block from the next GOP (not shown) for use in the decoding. As discussed above, in some embodiments, the image buffers 530 and 620 could comprise logical partitions of a memory array, while in other exemplary embodiments, such buffers could exist as discrete, physical image buffers connected to appropriate elements of an image processing pipeline.

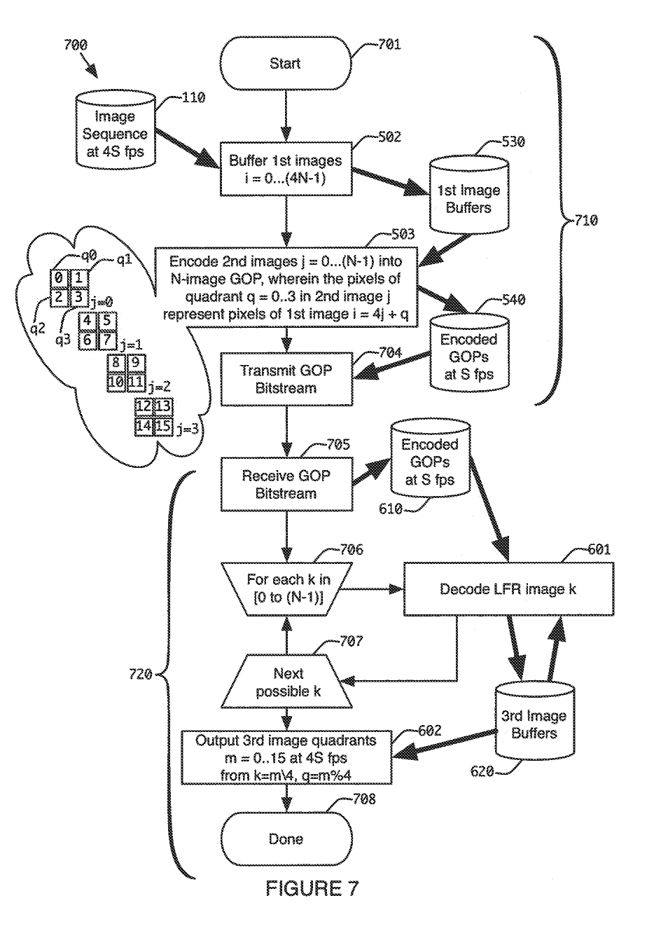

FIG. 7 shows another HFR encoding/decoding process 700 depicted in flowchart form, wherein an encoding stage 710 produces the encoded GOP 540 suitable for decoding by a decoding stage 720, the GOP transferred, for example, as a bitstream or as a file. The encoding performed by the encoding stage 710 begins during step 701 so that upon receipt of the HFR image sequence 110, the buffering of the supplied images will occur during the capture step 502. Again, for this example, the HFR comprises 4S, that is, four times the LFR considered as ‘S’. Again, for this example, ‘S’, the LFR could have a value of 30 frames per second (fps) in which case the HFR, being 4S, would be 120 fps. The encoding process 503 depicted in FIG. 7 remains consistent with that shown in FIG. 5, in which the number ‘N’ of LFR image blocks in a GOP is four. These ‘N’ LFR image blocks collectively corresponding to 4N HFR images, that is, sixteen. As before, the images under consideration in the capture buffer 530 have consecutively numbering 0 . . . 4N−1 (i.e., 0 . . . 15) and indexed by the index value ‘i’. The ‘N’ LFR image blocks are indexed by ‘j’, which takes the values from 0 to N−1 (i.e., 0 . . . 3). Here, the index ‘q’, which take the values 0 . . . 3, identifies the four quadrants. In this exemplary embodiment, the following equation specifies the relationship between the HFR images in capture buffer 530 and the tiling into the LFR image blocks for the encoded GOP 540:

LFR_Image[j].quadrant[q]=HFR_Image[i], for j=0 . . . 3, q=0 . . . 3, where i=jN+q Equation 2:

Note that Equation (2) differs from Equation (1) in terms of the computation of the index value ‘i.’ The encoded GOP 540 can undergo streaming during step 704 to another device to for decoding, or for storage as a non-transient file for subsequent decoding.

In embodiments where the encoding of the GOP includes bi-directional encoding between consecutive GOPs, an encoding of one GOP may require preparation of at least a portion of the next GOP (not shown).

In an exemplary embodiment of the decoding stage 720 of FIG. 7, the stream can undergo receipt and storage as the encoded GOP 610 as shown during step 705. Alternatively, the encoded GOP 610 could be received as a file. Unlike the encoding/decoding process 300, some embodiments of the decoding stage 720 could require not only the encoded GOP 610, but also the next consecutive encoded GOP (not shown) from the encoding stage 710, as would occur when using a bi-directional encoding scheme that required information from that next GOP. The decompression (decoding) performed during the loop beginning at step 706 occurs once per LFR image block for decoding, again indexed as ‘k’. However, during the decoding process 320 of FIG. 3, the index value k could run consecutively from 0 . . . N−1 (i.e., 0 . . . 3) when using only I-frames or P-frames for encoding, but the present decoding process 720 exploits B-frames, in which case the sequence of proper values for k will not be consecutive. Rather, the I- and/or P-frames required for a decoding of a particular B-frame will be decoded before a B-frame, even though at least one of those required frames will come after the B-frame in temporal order. As the k^{th} HFR image undergoes decoding and storage in the decoded LFR image block buffer 620, the individual quadrants q (0 . . . 3) will correspond to a decompressed HFR image ‘m’, where m runs from 0 . . . 4N−1 (i.e., 0 . . . 15) and m=4k+q. When the decompression loop 707 completes, which in an embodiment that employs B-frame encoding between two consecutive GOP can occur after at least a partial decoding of the next GOP (not shown), the output process 602 provides restored HFR image blocks (e.g., blocks 631-646) in the reconstructed image sequence 630, indexed by m, and ready for presentation during step 603, e.g., to the HFR display device 650.

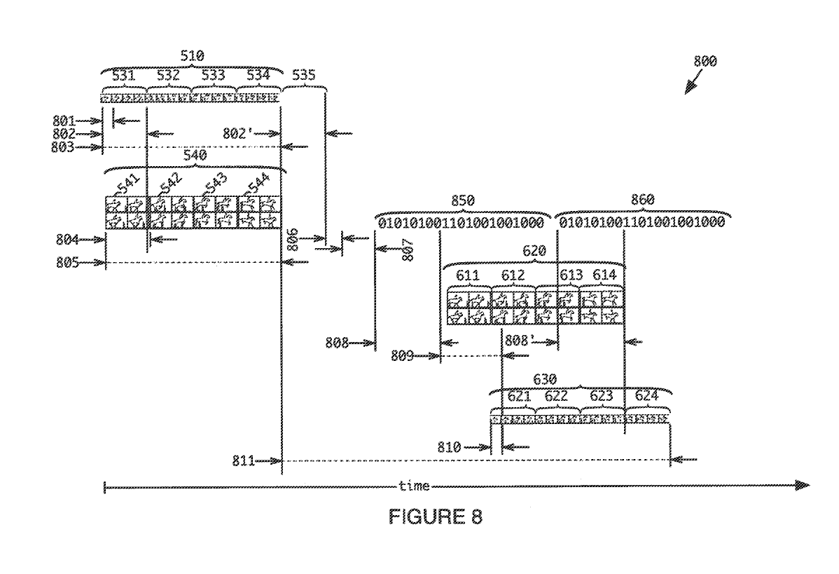

FIG. 8 shows a timing diagram 800 illustrating one exemplary execution of the HFR encoding/decoding process 700. In FIG. 8, time advances from left to right in this diagram, though not within an individual image, for example, sub-sequence 531 comprises four individual HFR images. These images present sequentially. However, within those individual HFR images, an indication of a temporal context exists, other than when the image capture starts and ends (e.g., no implied ordering or timing of pixels, rows, columns) Likewise, the encoding process which creates encoded GOP 540 takes place where the encoded GOP 540 appears (plus additional computational time as necessary), but individual LFR images, e.g., 541, are not temporally representative.

The HFR frame time 801 constitutes the reciprocal of the HFR. The first sub-sequence 531, comprising the four images 111-114 (from FIG. 5), appears over the interval 802, comprising a period four times the HFR frame time 801. The interval 803 represents the period for presenting the sixteen images 111-126 (from FIG. 5) of stream portion 110. The duration represented by the LFR frame time 804 constitutes the reciprocal of the LFR, but does not necessarily correspond to an LFR image block being available at the time shown. As an example, the LFR image block 541 is comprised of four quadrants, each populated from the first HFR sub-sequence, that is, HFR images 111-114. However, the encoding of the LFR image block can require information regarding the content of subsequent LFR image blocks (e.g., one or more of LFR image blocks 542-544). In some embodiments, the encoding of later LFR image blocks (e.g., LFR image block 544) cannot occur until receipt of the first LFR image block from the subsequent GOP (not shown) completes. The encoding process 503 begins following some latency interval after capture of the first HFR image of the sub-sequence 531 begins. The interval 805 runs from the start of the encoding process 503 to the time when capture of sequence 510 completes. For those embodiments relying on information from the next GOP, the interval 802 represents the time to capture the HFR images (not shown) of the next sub-sequence 535. The interval 806 represents the remaining duration of the encoding process 503. Once the encoded GOP 540 is complete, an arbitrary latency occurs, which by way of example in a real-time streaming application would include (a) transmission latency 807 comprised of a setup time to ready the encoded GOP 540 for transmission, the transmit buffer wait time, and the actual network transport latency, (b) the actual network transport duration, here represented as the width of bitstream segment 850 (as with bitstream 450 above, symbolically illustrated herein as a few nonsensical bits), and (c) the receive-buffer wait time 808. The received and buffered bitstream segment 850 corresponds to the encoded GOP 610.

Note that in this example, the receive-buffer wait time 808 has a negative value, such that the decoding process 601 begins to populate the decoded image buffer 620 from the bitstream segment 850 (encoded GOP 610) even before complete receipt of the bitstream segment 850. (In an alternative embodiment, the receive buffer wait time 808 could have a positive value several seconds long, providing a deep receive buffer period which can allow for missing packet replacement or forward error correction techniques). The decoding process 601 proceeds, and by completion of the interval 809, the decoded LFR image block 611 within the buffer 620 has populated. Within the buffer 620, each of the four LFR image blocks 611-614 will undergo decoding, though not necessarily in the order corresponding to the temporal capture of the HFR images included therein. Care must be taken in the timing so as not to begin the output process 602 too soon, lest an HFR image be required for display before it has been decoded. While the images of the first composite LFR image block 611 can be ready, consecutive LFR image blocks (e.g., blocks 612-614) cannot be ready with each successive HFR frame time in embodiments using B-frame encodings, since a later frame can may be needed before an earlier one can be decoded. The output process 602 provides the restored HFR frames 631-646 (from FIG. 6), one per HFR frame interval, in order, in the reconstructed frame sequence 630. The output buffer wait time 810, in this example, also has a negative value, indicating that, for some embodiments, the output of image sequence 630 can begin before decoding process 601 has finished filling the decoded LFR image block buffer 620. In this example, the wait time 810 appears as being about negative one times the HFR frame time, but the wait time 810 is primarily determined in the case of B-frame encoding because the decoding and output of the fourth sub-sequence 624 requires access to at least a portion of the next GOP 860 to undergo buffering and decoding (not shown), for which the buffer wait time 808′ is similar to the buffer wait time 808. Ultimately, the total pipeline latency 811 will measure the time period running from when the time sub-sequence 534 finishes capture to the time the corresponding sub-sequence 624 finishes output. Here, too, for those embodiments where files serve to store a time-compressed image sequence for later playback, the interval between the encode process 710 and the decode process 720 can have am an arbitrarily long value.

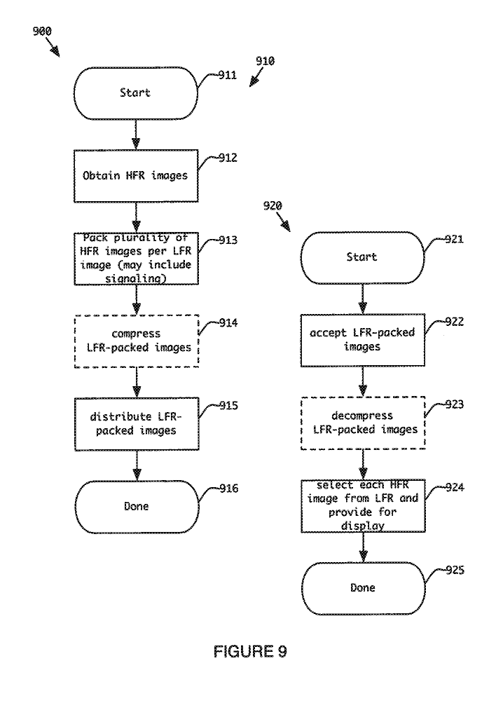

FIG. 9 shows a simplified block diagram for the HFR encoding/decoding technique 900, showing the separate HFR encoding process 910 and HFR decoding process 920. The encoding process 910 commences at step 911 with buffers ready to receive HFR images. During step 912, the buffers obtain the HFR images, whether as files or as a bitstream representing the images. During step 913, packing of a plurality of HFR images into each LFR image block occurs. In some embodiments, metadata can signal the particular pattern of packing used, when more than one is available. This metadata can accompany each LFR image block or can accompany a plurality of LFR image blocks (e.g., depending on the embodiment, within each encoded GOP, periodically within an LFR image block stream, whether or not encoded, or just once for a particular piece of content). Optionally, during step 914, the LFR image blocks can undergo compression, to provide a more compact representation. Data representing the LFR image blocks, whether or not compressed, is distributed at step 915, either as a non-transient file, for example in a computer memory or removable media (e.g., like a DVD), or as a bitstream. The encoding process 910 concludes at step 916.

The decoding process 920 commences during step 921, with buffers ready to receive frame rate compressed HFR images as LFR image blocks. Acceptance of the LFR image blocks occurs during step 922. Optionally, during step 923, the LFR image blocks undergo decompression (i.e., for image blocks compressed as in step 914). During step 924, the unpacking of the LFR image blocks occurs by selecting each HFR image from an LFR image block and providing that HFR image for display or transmission. In an alternative embodiment, instead of providing the HFR image for display, the unpacking step 924 can store the unpacked HFR images in a non-transient form for use at a later time. The decoding process 920 concludes at step 925.

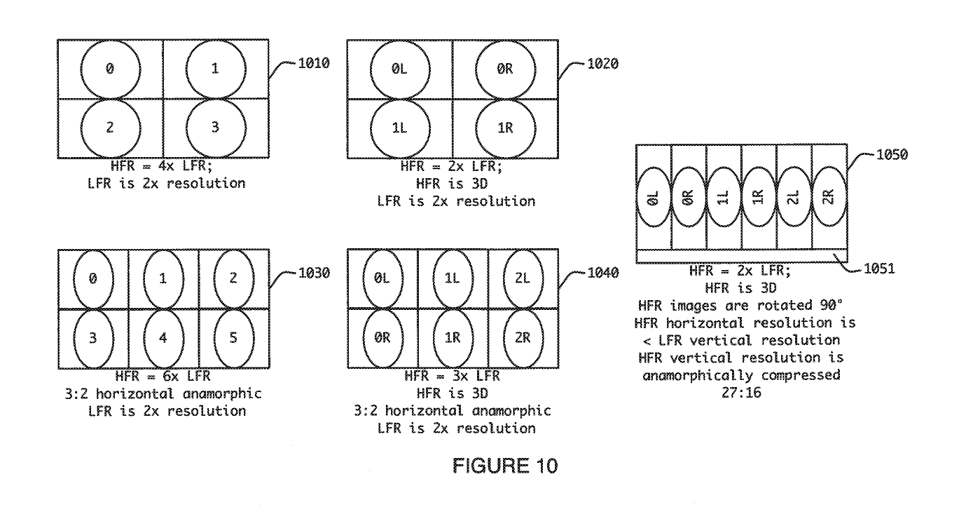

The examples thus far discussed refer to HFR images being frame rate compressed at a ratio of 4:1, that is, four HFR images being packed into each LFR image block, with the frame rate of the LFR image blocks being ¼ that of the HFR images. FIG. 10 illustrates several alternative example HFR packing patterns, by way of example and not of limitation. In FIG. 10, the packing pattern 1010 reprises the packing pattern familiar from FIG. 5 above, with four HFR images 0 . . . 3 assembled into a single LFR image block, so that the HFR is four times the LFR. In one configuration of pattern 1010 of FIG. 10, the LFR resolution in each axis is twice that of the HFR image, which is to say, the LFR image block has four times as many pixels as a single HFR image, and each pixel of an HFR image is represented by a full pixel in the LFR image block. The circles inside the individual HFR images illustrate that the original aspect ratio (16:9 throughout these examples) of the HFR image is maintained while packed into the LFR image block (also having a 16:9 aspect ratio).

In another embodiment using packing pattern 1010, the HFR images and the LFR image block could have the same size, that is, both could have the same resolution, in which case the resolution of each HFR image becomes reduced (scaled or decimated to a lower resolution) when packed into the LFR image block at the expense of being a little blurry (i.e., losing some detail) when decompressed and restored (re-scaled) back to the original resolution. Similarly, in other embodiments in which the HFR images are less than half the resolution of the LFR image block (in each axis), but do have substantially the same aspect ratio, the HFR images are scaled accordingly to achieve a packing pattern 1010 and upon unpacking can be restored to their original resolution (though still losing some detail), or to a different resolution, for display. Other decimation patterns could be used line like quincunx instead of simple scaling if a need exists to scale down source images and later re-interpolate the missing information.

Packing pattern 1030 shows a different packing configuration, and illustrates an “anamorphic packing”, that is, the horizontal and vertical axes of the HFR images have different scaling values when packed into an LFR image block. This asymmetrical scaling of the horizontal and vertical axes may be required when the original HFR images and the LFR image block have different aspect ratios, or because the horizontal and vertical tilings are not equal, as illustrated here. As seen in packing pattern 1030, six HFR images 0 . . . 5 are packed into a single LFR image block, in a 3-by-2 array (the horizontal tiling of three is not equal to the vertical tiling of 2). Accordingly, for this example, the HFR is six times that of the LFR. In one example of this packing pattern, the LFR image block has twice the resolution, on each axis, of the original HFR images. Again, the original HFR images and the LFR image block have the same aspect ratio. However, this only leaves room for four HFR images to be packed without some loss of resolution. Rather than scaling the whole image uniformly, an anamorphic compression is applied, turning circles into ellipses. Three HFR images are compressed into the horizontal resolution previously occupied by two HFR images, or a 3:2 horizontal compression. In the vertical axis, these HFR images are not compressed, but upon unpacking, the horizontal axis will undergo a 2:3 expansion, restoring the original HFR image resolution, though with some loss of horizontal detail.

Frame rate compression as discussed can also be applied to stereoscopic images. The packing pattern 1020 shows two stereoscopic pairs: left- and right-eye pair ‘0’ (‘0L’ being the left image for pair 0, ‘0R’ being the right image), and left- and right-eye pair ‘1’ (similarly designated). The packing is similar to that of pattern 1010, where four images are packed into a single LFR image block, but here the HFR only exceeds reaches twice that of the LFR because for each frame interval two images, the left and right images of a stereoscopic pair are required. In this packing pattern, the left images appear on the left, and the right images appear on the right.

The packing pattern 1040 also applies to stereoscopic image pairs, but here the left-eye images appear on the top, 0L, 1L, 2L, and the right-eye images appear on the bottom, 0R, 1R, 2R. The HFR is three times the LFR. The images undergo packing with an anamorphic compression, as with pattern 1030, where the horizontal axis of the images is compressed 3:2. A checkerboard decimation could be used instead of a basic scaling to enhance the quality of the reconstructed images

Additionally, the HFR images can be rotated when packed into the LFR image block. An example of this appears in the packing pattern 1050. Three stereoscopic image pairs, similar to those packed into pattern 1040, have been rotated 90°, and packed as a single row in a single LFR image block. In one embodiment, the original horizontal resolution of these HFR images is less than the vertical resolution of the LFR image block, so the horizontal axis of the original HFR images is unsealed and a region of unused LFR image block space 1051 remains. However, the original vertical resolution of the HFR images exceeds ⅙ of the horizontal resolution of the LFR image block, requiring the HFR images to be compressed 27:16 in order to be packed six across. Though the total compression, and therefore loss of detail, is greater in packing pattern 1050 than in pattern 1040, it leaves the horizontal axis of the original HFR images untouched. This can be a particular advantage for stereoscopic images, where perception of the stereoscopic 3D effect is strongly influenced by subtle left- and right-eye image differences in the horizontal direction. In this example, the 90° rotation preserves the original HFR image horizontal axis, and thus better retains horizontal details pertinent to the perception of the 3D effect. Another advantage is that passive stereoscopic displays interlace left and right images, so they already use only half of vertical resolution but 100% of horizontal resolution, so preserving horizontal detail will provide superior images on those displays

Many different packing patterns can be developed using these principles. If a system only ever applies or receives one packing pattern, then the encoding is uniform. However, for systems that use a plurality of packing patterns, metadata should be provided to indicate which packing pattern is being applied when. Such metadata could provide the individual settings of each packing parameter, for example, the sequence of the HFR images within the LFR image block, the vertical and horizontal compression ratios, rotations, whether or not the HFR images are 3D, where left- and right-eye images are located, the ratio of HFR and LFR frame rates, or a prescription for the HFR frame rate. If a few particular combinations among all possible combinations of parameters are used in a system, each of those combinations might be used to define a corresponding “mode”, so that the metadata merely need identify the “mode” being used, rather than each of the individual parameters independently.

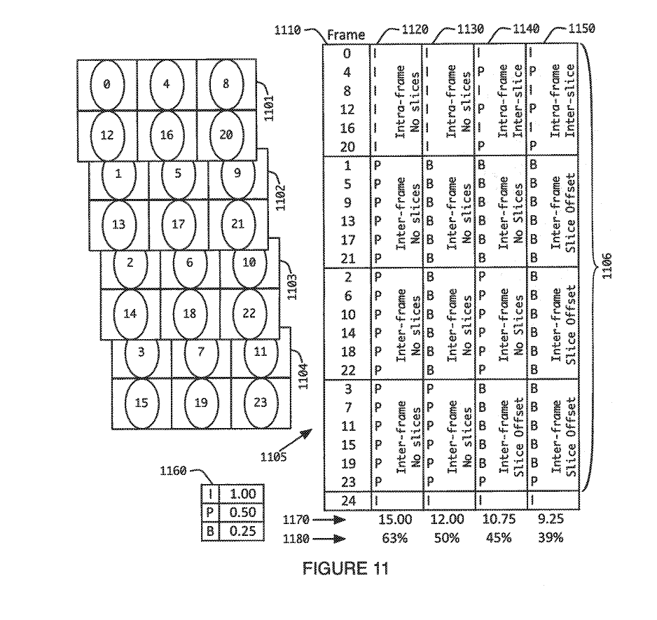

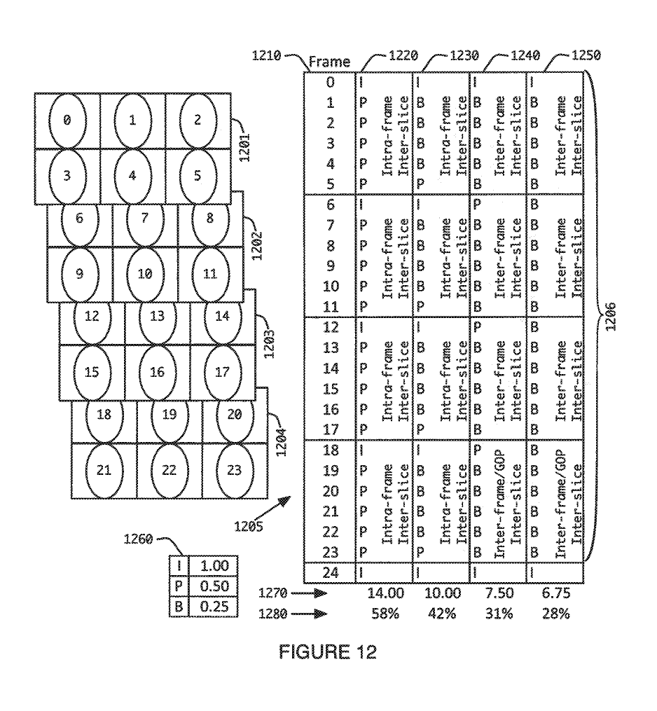

FIGS. 11 and 12 each show several example encoding schemes for HFR images packed into LFR image blocks. These examples are based on packing scheme 1030, where six HFR images are packed into each LFR image block. FIG. 11 shows packed LFR image blocks 1101-1104, where consecutive HFR images are inserted into consecutive LFR image blocks of the group. The numbers inside the ellipses indicate the original temporal sequence within the capture stream portion. The table 1105 identifies four different exemplary encoding schemes, 1120, 1130, 1140, and 1150 describing the encoding of the particular HFR image listed in column 1110. The bracket 1106 identifies the limits of the current GOP. The bottom row, for HFR image 24, begins the next GOP.

The column for encoding 1120 represents a traditional I- and P-frame encoding of the LFR stream. The first LFR image block 1101 undergoes encoding as an I-frame, that is, only intra-frame encoding is used and could be decoded without reference to any other frame. This is shown in each of the first six rows of column 1120 by an “I”, each corresponding to the six HFR images in first LFR image block 1101. The next LFR image blocks 1102-1104 are encoded as P-frames, requiring access to the decoded I-frame 1101 for their own decoding. No reference to the next GOP is required to decode GOP 1106, a fact consistent throughout FIG. 11.

The encoding 1130 uses some B-frame encoding, but strictly within the GOP 1106. The second and third LFR image blocks 1102 and 1103 are B-frame encoded using the I-frame encoded first LFR image block 1101 and P-frame encoded fourth LFR image block 1104.

The encoding 1140 introduces a new concept for slice encoding within a single frame, where slices are used to represent the individual HFR images as packed within an LFR image block. Here, the encoding of LFR image block 1101 uses an I-slice corresponding to HFR images 0, 8, and 16 and P-slices based correspondingly on those I-slices for HFR images 4, 12, and 20. Each HFR image 2, 6, 10, 14, 18, 22 in the third LFR image block 1103 is represented as a P-slice taken from the correspondingly earlier I-frame in the first LFR image block 1101 (or, depending on implementation, could be derived from the earlier P-slice, if suitable). The second LFR image block 1102 is encoded here as a collection of B-slices, each referencing the corresponding prior and subsequent I- and/or P-slice(s). For example, the HFR image 1 would be encoded as a B-slice based on the I-slice corresponding to the HFR image 0 and the P-slice corresponding to the HFR image 2. The HFR image 5 could be encoded as a B-slice based on the I-slice corresponding to HFR image 0 (or the P-slice for HFR image 4) and the P-slice corresponding to HFR image 6. The fourth LFR image block 1104 is encoded as mostly B-slices, based on the prior P-slices of the third LFR image block 1103, and (temporally) later I- or P-slices from the first LFR image block 1101.

Note that for the B-slices of fourth LFR image block 1104, each B-slice holds a position within the image block 1104 matching that of the corresponding earlier P-slices of the third LFR image block 1103, but the same is not true with respect to the corresponding later I- or P-slices in the first LFR image block 1101, for which the later slices hold a different position with the image block 1101, a property herein termed “slice offset”. The corresponding later slice occupies a position corresponding to the next position within the intra-frame packing sequence (e.g., the later I-slice needed to decode the slice representing HFR image 7 in LFR image block 1104 is the slice representing HFR image 8, whose position in LFR image block 1101 corresponds with the position of HFR image 11, the next HFR image packed in LFR image block 1104 after HFR image 7). The exception is the encoding for HFR image 23, which is shown as a P-slice rather than referencing an HFR image data outside of the GOP 1106, thereby allowing GOP 1106 to be fully decoded without reference to another GOP.

The Table 1160 in FIG. 1 depicts a crude estimation of representational efficiency, where the encoding of an I-frame (or I-slice) is normalized to 1.0, such that a P-frame (or P-slice) consumes approximately ½ the space (0.5) and a B-frame (B-slice) about ¼ (0.25). The row 1170 shows the sums of these representation efficiencies for each column, where 24.0 would be the size of an all-I-frame (I-slice) encoded GOP. The row 1180 shows the percentage efficiency of each encoding scheme, compared to an all-I-frame encoding.

FIG. 12 shows packed LFR image blocks 1201-1204, where consecutive HFR images are inserted into the same LFR image block, until that LFR image block is fully packed. Subsequent HFR images are packed into the next LFR image block until it fills, and so on. Again, the numbers inside the ellipses indicate the original temporal sequence within the capture stream portion. The table 1205 identifies four different example encoding schemes, 1220, 1230, 1240, and 1250 describing how the particular HFR image listed in column 1210 is encoded. The bracket 1206 identifies the limits of the current GOP, but applies only to encoding schemes 1240 and 1250, as will be discussed below. The bottom row, for HFR image 24, begins a new GOP.

The column for encoding 1220 illustrates a configuration with each LFR image block being strictly intra-frame encoded (that is, where the encoding for a LFR image block is achieved without reference to any other image block). However, within each frame, only one slice (corresponding to HFR images 0, 6, 12, and 18) is intra-slice encoded, and each other slice (corresponding to HFR images 1 . . . 5 in the LFR image block 1201) is inter-slice encoded, as P-slices relative to the I-slice. Notice that the I-slice must be decoded before any of the P-slices are decoded within a single LFR image block: This can diverge from some prior art decoding techniques which expect the slices within an image to be separately and independently decodable by parallel processors, where the P-slices make reference to I-slices that were decoded for a previous image (here, a previous LFR image block). Note, too, that the parallel processing can still be supported, for instance if the I-slice is composed of multiple tiles, each can be separately and independently processed, after which the P-slices (tiled or otherwise) can be separately and independently processed, making reference to the decoded I-slice in the same LFR image block. Further note that the current comments regarding parallel processing of slices and tiles can be applicable in other of these example encodings, however for brevity, the subject is not revisited each time. Because every LFR image block in encoding 1220 is intra-frame encoded, the GOP length is effectively one (hence, bracket 1206 does not apply). Each LFR image block can be decoded independently.

Note how the encoding scheme of column 1220 differs from 1120, due to the fact that the HFR images packed into LFR image block 1201 are consecutive, and thus more likely to benefit from inter-slice encodings, whereas in LFR image block 1101, the HFR images are temporally spaced further apart, in which case we would expect a reduction (though not a complete elimination) of the value of inter-slice encoding.

The encoding 1230 also remains intra-frame throughout. Accordingly, the effective GOP length for encoding 1230 is also one. However, the encoding 1230 uses B-slice encoding. In each LFR image block, the first (e.g., HFR image 0) is I-slice encoded, and the last (e.g., HFR image 5) is P-slice encoded. The remaining LFR image blocks 1 . . . 4 are B-slices, and require the decoding of LFR image blocks 0 and 5 before they can be processed, since the B-slices are encoded with respect to the temporally nearest I- and/or P-slices surrounding them.

The encoding 1240 uses inter-frame encoding for all frames (which is not a typical practice). The I-slice for HFR image 0 in LFR image block 1201 must be decoded first, then the P-slice in the next LFR image block 1202. Only then can the B-slices in LFR image block 1201 (representing HFR images 1-5) be decoded, which makes the first LFR image block 1201 in GOP 1206 dependent on another image. Likewise, the P-slices in consecutive LFR image blocks 1203 and 1204 must be decoded before the B-slices in LFR image blocks 1202 and 1203, respectively. Before the B-slices in LFR image block 1204 can be decoded (corresponding to HFR images 19-23), the I-slice at the start of the next GOP, and corresponding to HFR image 24, must be received and decoded.

The encoding 1250 takes this to an extreme, where no LFR image block in GOP 1206 can be decoded without first receiving at least a first portion of the next GOP to obtain the I-slice encoded HFR image 24, since all HFR images 1 . . . 23 are B-slices that depend on the HFR images 0 and 24.

The encodings 1240 and 1250 could break the dependency between GOPs by encoding the last HFR image 23 in the GOP 1206 as an independent I-slice, or a P-slice dependent on the I-slice representing HFR image 0 in LFR image block 1201.

The table 1260 shows a crude estimation of representational efficiency, where the encoding of an I-frame (or I-slice) is again normalized to 1.0, such that a P-frame (or P-slice) consumes approximately ½ the space (0.5) and a B-frame (B-slice) about ¼ (0.25). The row 1270 indicates the sums of these representation efficiencies for each column, where 24.0 would be the size of an all-I-frame (I-slice) encoded GOP. The row 1280 shows the percentage efficiency of each encoding scheme, compared to an all-I-frame encoding. In comparison to the 50% efficiency provided by the I-, P-, B-frames in encoding 1130 (from row 1180), the intra-frame encoding 1230 (using intra-frame but I-, P-, and B-slices within the frame), is almost 10% more efficient (42%, from row 1280), while the inter-frame/inter-slice encoding 1240 is about 20% more efficient (31%, from row 1280).

Additional metadata can be provided to describe the encoding pattern of I- P- and B-frames (e.g., in example encodings 1120, 1130) and/or I-, P-, and B-slices (e.g., in example encodings 1140, 1150, 1220, 1230, 1240, and 1250) for those embodiments where more than one encoding pattern is allowed.

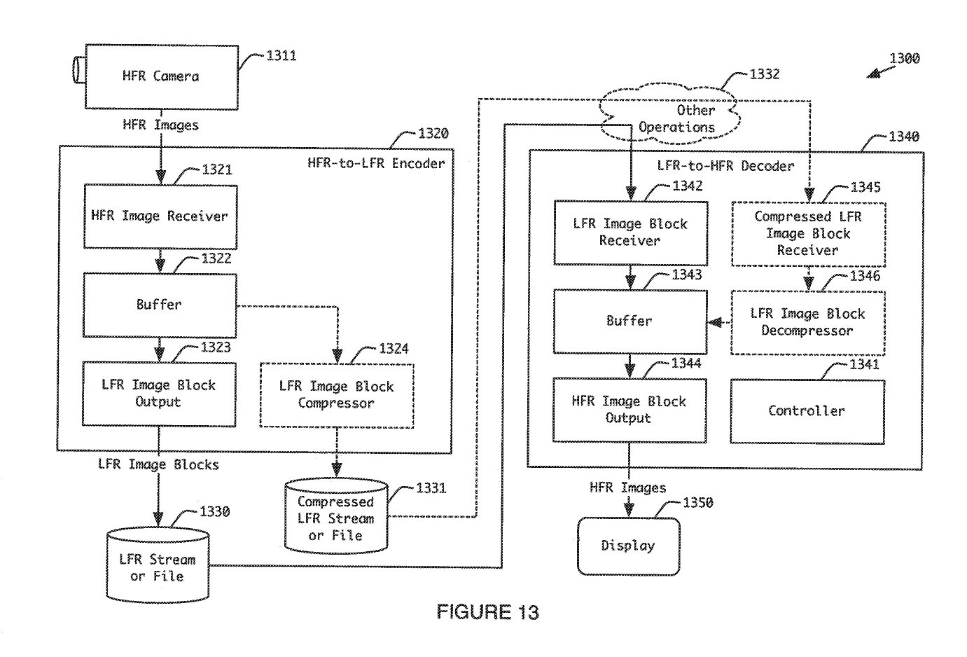

FIG. 13 illustrates a block diagram of one example of a high frame rate processing system 1300, comprising an HFR-to-LFR encoder 1320 and a LFR-to-HFR decoder 1340. As an example, an HFR camera 1311 provides a series of HFR images to the HFR image receiver module 1321 of the HFR-to-LFR encoder 1320. The HFR image receiver module 1321 writes the received HFR images to buffer 1322. When sufficient HFR images have accumulated in the buffer 1322, the LFR image block output module 1323 will output LFR image blocks (having the high frame rate images tiled therein as discussed previously). In practice, the LFR image block module 1323 will output the LFR image blocks as an LFR image stream or file 1330 for immediate transmission or later use. In an alternative embodiment, an LFR image block compressor module 1324 can access the buffer 1322 to output resulting compressed LFR image blocks as a compressed LFR image stream or file 1331. In this regard, the LFR image block compressor module 1324 will also tile the HFR images into at least one LFR image block. Either of the LFR image block output module 1323 or the compressed LFR image block output module 1324 may supply metadata to indicate the nature of the image block tiling or compression. Rather than being comprised of the HFR image receiver module 1321, the buffer 1322 and the LFR image block output module 1323 (or LFR image block compressor 1324), the HFR-to-LFR encoder could be comprised of a single processor or similar device (not shown) that performs the collective functions of these elements.

Note that the LFR stream or file 1330 and/or the compressed LFR stream or file 1331 can take the form of an existing moving image stream or file format, such as those described by the Moving Pictures Expert Group (MPEG): In some embodiments, the HFR to LFR encoder 1320 acquires HFR images (e.g., from camera 1311) and packages them into well-known moving image formats, which by comparison to the HFR, comprise an LFR format. Examples of such encodings appear in columns 1120 and 1130 of table 1105 in FIG. 11. As examples, the remainder of table 1105 and table 1203 in FIG. 12 represent other embodiments in which the format of the compressed LFR stream or file 1331 departs from prior art formats and takes advantage of redundancies that may be present due to the tiled nature of the LFR image blocks 1330.

The LFR stream or file 1330 may optionally undergo other operations 1332, for example transmission, switching, editing or compression. Similarly, the compressed LFR stream or file 1331, when provided, may also undergo other operations 1332, for example, transmission, switching, editing, or still further compression.

Following such other operations 1332, the LFR stream or file 1330 undergoes receipt by an LFR image block receiver module 1342 of the LFR-to-HFR decoder 1340 for storage in in a buffer 1343. In some embodiments, the receiver module 1342 can re-request missing portions of LFR stream or file 1330 or exercise a forward error correction or other mechanism to detect and/or recover from communication and/or processing errors. In cases where the compressed LFR stream or file 1331 undergoes receipt by the decoder 1340, the compressed LFR image block receiver module 1345 provides LFR images to a LFR image block decompressor module 1346, which in turn stores the decompressed LFR image blocks into buffer 1343. An HFR image block output module 1344 unpacks individual HFR images from buffer 1343 and provides them as the output of decoder 1340, for example to an HFR display 1350.

If metadata accompanies a received LFR image block in the receiver module 1342 or accompanies a compressed LFR image block in the receiver module 1345, the metadata can serve to determine the mode of tiling and/or compression, or other information about the LFR image block.

The compression performed by the LFR image block compressor 1324 can include motion-based compression as discussed, using either I-frame, I- and B-frame or I-, B- and P-frame encoding. Likewise, the decompression performed by the HFR image block decompressor 1324 can include motion-based decompression as discussed, using either I-frame, I- and B-frame or I-, B- and P-frame decoding.

The foregoing describes a technique for compressing (encoding) high frame rate video.

1-61. (canceled)

62. A method for processing source content having High Frame Rate (HFR) images, comprising:
tiling the HFR images of the source content into at least one Low Frame Rate (LFR) image block having a frame rate lower than the HFR images by encapsulating successive sets of HFR images into separate corners of the LFR image block and;
performing at least one operation on the at least one image block.

63. The method according to claim 62, wherein the source content has a resolution equal to the least one LFR image block.

64. The method according to claim 62, wherein the images of the source content undergo scaling anamorphically prior to tiling into the at least one image block.

65. The method according to claim 62, wherein the source content comprises 3D stereoscopic image pairs each image pair having a right-eye and left-eye image.

66. The method according to claim 62, wherein the at least one operation includes an editing operation.

67. The method according to claim 62, wherein the at least one operation includes a one of a compression or decompression operation.

68. The method according to claim 67, wherein the decompression operation is motion-based compression.

69. The method according to claim 68, further comprising the step of determining metadata indicative of the motion-based compression.

70. The method according to claim 68, wherein the motion-based compression uses intra-frame encoding.

71. The method according to claim 68 wherein the motion-based compression further uses at least one of progressive frame and bi-directional frame encoding.

72. The method according to claim 68 wherein the motion-based compression uses slice encoding.

73. A method for decoding High Frame Rate (HFR) images of source content tiled in at least one Low Frame Rate (LFR) image block having a first frame rate lower than the High Frame Rate, comprising the steps:
selecting successive images tiled in the at least one image block by decapsulating successive sets of the HFR images that were encapsulated into separate corners of the LFR image block; and
sequentially providing the selected images for display at a second frame rate higher than the first frame rate.

74. The method according to claim 73, wherein the source content has a resolution equal to the least one LFR image block.

75. The method according to claim 73, wherein the images of the source content undergo scaling anamorphically prior to tiling into the at least one image block.

76. The method according to claim 73, wherein the source content comprises 3D stereoscopic image pairs each image pair having a right-eye and left-eye image.

77. Apparatus for encoding high frame rate (HFR) images of source content at a first frame rate, said apparatus comprising:
a receiver for receiving the HFR images;
a buffer for storing the HFR images of the source content received by the receiver; and
an image block output module for outputting at least one Low Frame Rate (LFR) image block at a second frame rate less than the High Frame Rate, the at least one image block having the images tiled therein by encapsulating successive sets of HFR images into separate corners of the LFR image block.

78. The apparatus according to claim 77, wherein the source content has a resolution equal to the least one LFR image block.

79. The apparatus according to claim 77, wherein the images of the source content undergo scaling anamorphically prior to tiling into the at least one image block.

80. The apparatus according to claim 77, wherein the source content comprises 3D stereoscopic image pairs each image pair having a right-eye and left-eye image.

81. The apparatus according to claim 77, wherein the image block output module compresses the at least one image block using motion-based compression, and said motion-based compression further uses at least one of progressive frame and bi-directional frame encoding.

82. Apparatus for decoding High Frame Rate (HFR) images of source content tiled in at least one image block having a first frame rate, comprising:
a receiver for receiving the at least one Low Frame Rate (LFR) image block;
a buffer for storing the at least one LFR image block received by the receiver; and
an image block output module configured to select successive HFR images of the source content tiled in the at least one image block by encapsulating successive sets of HFR images into separate corners of the LFR image block; and sequentially provide the selected images for display at a second frame rate higher than the first frame rate.

83. The apparatus according to claim 82, wherein the source content has a resolution equal to the least one LFR image block.

84. The apparatus according to claim 82, wherein the images of the source content undergo scaling anamorphically prior to tiling into the at least one image block.

85. The apparatus according to claim 82, wherein the source content comprises 3D stereoscopic image pairs each image pair having a right-eye and left-eye image.
